(19) United States
(12) Patent Application Publication
(10) Pub. No.: US 2009/0125567 A1
(43) Pub. Date: May 14, 2009

(54) SYSTEM AND METHOD FOR VOLUNTEER REGISTRATION AND MANAGEMENT

(76) Inventor: George McNeill Ray, Dallas, TX (US)

Correspondence Address: MICHAEL RIES, 318 PARKER PLACE, OSWEGO, IL, 60543, US

(21) Appl. No.: 12/268,448

(22) Filed: Nov. 11, 2008

Related U.S. Application Data
(60) Provisional application No. 60/987,378, filed on Nov. 12, 2007.

(51) Int. Cl. G06F 17/30

(52) U.S. Cl. 707/201; 707/E17.005

(57) ABSTRACT

This system and method provides a capability to enter, store, and maintain data associated with one or more organizations, organization-specific commit tees, and organization-specific volunteers. This system and method also includes processes for a volunteer to join committees, resign from committees, nominate committee chairs, manage committees, get reports, and communicate with other volunteers. Some volunteers will be designated as organization-specific administrators with privileges to administer all of their organization's data and processes. Lastly, this system and method supports a super-user with privileges to administer all organizations and their administrators.

This application claims priority to U.S. Provisional Application 60/987,378 filed Nov. 12, 2007, the entire disclosure of which is incorporated by reference.

### BACKGROUND OF THE INVENTION

1. Field of Invention

This invention relates, in general, to the acquisition and management of information among a group of individuals and, in particular, to a system and method for volunteer registration and management.

2. Background of the Invention

The prior art requires prospective volunteers to obtain a paper registration form and imposes a registration deadline. The prospective volunteer manually completes the form, specifying contact information and desired committees. Using FAX or US Mail, the prospective volunteer sends the completed form to the organization's Volunteer Coordinator. The Volunteer Coordinator types the volunteer's contact information into a separate spreadsheet for each desired committee. After the registration deadline, the Volunteer Coordinator emails the appropriate spreadsheet to the committee's Chair.

For forms received after the deadline, the Volunteer Coordinator makes a copy of the form for each desired committee and using US Mail, sends the copy to the appropriate committee Chair.

The committee Chair does not know how many people volunteered until the spreadsheet arrives. After the spreadsheet arrives, the Chair may need to solicit additional volunteers. Alternatively, the Chair may need to advise some volunteers they are not needed if too many people volunteered. The Chair also needs to handle registration forms received after the deadline.

Committee Chairs choosing to communicate with their roster of volunteers using email generally create a distribution list.

Organizations generally employ a Nominating Committee to designate committee Chairs and the organization's Board Members. The Nominating Committee solicits volunteers for these leadership positions and announces selections for the next term of office.

The prior art suffers from a number of disadvantages, including:

a) The prospective volunteer needs to obtain the paper registration form. The organization must publish forms, maintain an inventory of forms and make forms available to prospective volunteers.

b) The obtained registration form may be out of date. The organization may make changes to forms, but a prior version of the form may make its way into the hands of prospective volunteers.

c) The labor intensive activity of transcribing data from the registration form to the spreadsheet easily results in typographical errors. The registration form must be completed manually with a pen or pencil and the prospective volunteer's hand writing may not be legible.

d) The prospective volunteer must send the registration form to the Volunteer Coordinator using FAX, US Mail, or hand delivery. The Volunteer Coordinator needs: 1) a FAX machine and the prospective volunteer needs to know the telephone number, or 2) the prospective volunteer needs an envelope, adequate postage, and the Volunteer Coordinator's address, or 3) the time and place to make a hand delivery.

e) The multi-step registration process dissuades volunteering. While each step requires little time, interruptions between steps may be lengthy. The prospective volunteer can easily miss the registration deadline and choose not to volunteer rather than submit the form late.

f) Inadequate job descriptions dissuade prospective volunteers from joining committees. The committee selection section of the registration form generally provides the name of a committee and a check box. Including committee-related job descriptions can turn the form into a pamphlet.

g) The prospective volunteer's contact information may change, but the prospective volunteer has no process to provide updates.

h) The prospective volunteer's committee preferences may change, but the prospective volunteer has no process to provide updates.

i) The single registration deadline occurs before individual committee deadlines. The Volunteer Coordinator needs to deliver spreadsheets to committee Chairs on a date certain, but committee work may not commence for some time after the registration deadline.

j) Committee Chairs may have inadequate time to respond to roster shortfalls. When committee work commences immediately after the registration deadline, the committee Chair has inadequate time to recruit additional volunteers if needed. Typically the committee work gets delayed while the Chair recruits more volunteers.

k) Committee Chairs may need to thin roster surpluses. Popular committees commonly receive too many volunteers. The committee Chair must then choose which volunteers to exclude and inform these people they are not needed without alienating them as future volunteers.

l) Committee Chairs need to manually update message distribution lists. After receiving the volunteer roster (spreadsheet) and late registration forms, committee Chairs commonly create an email distribution list using their personal message client. As the committee's volunteers join and leave the committee, the Chair must update the distribution list. If the organization needs to replace a Chair before the term of office expires, the new Chair must create the distribution list from scratch or obtain a copy from the out-going Chair.

m) Volunteers perceive the leadership staffing process as exclusive and secretive. Organizations typically designate committee Chairs before soliciting for committee volunteers. Thus, the registration form generally provides the opportunity to volunteer for committee work, but not to volunteer as the Chair of a committee. Organizations typically solicit for candidates to fill leadership positions separately and less openly.

n) Organizations lack the ability to easily generate useful reports about the volunteer community, committees, or the volunteer management process.

o) Registration forms rarely ask prospective volunteers for suggestions on improving the volunteer registration and management process.

3. Objects and Advantages

The new process includes several objects and advantages, including:

a) To eliminate the paper registration form;

b) To ensure prospective volunteers only have access to current registration forms;

c) To eliminate the labor intensive transcription and illegibly written data.

d) To eliminate the need to send a registration form to the Volunteer Coordinator;

e) To eliminate the registration deadline and simplify the registration process;

f) To provide complete, comprehensive job descriptions and provide prospective volunteers with a clear understanding of the expected commitment before joining a committee;

g) To provide volunteers with a near real-time process to update contact information seven days a week, twenty-four hours a day;

h) To provide volunteers with a near real-time process to update committee preferences seven days a week, twenty-four hours a day;

i) To allow volunteers to opt-in or opt-out of committees based on individual, committee-specific deadlines rather than the registration deadline;

j) To provide the organization and committee Chair with near real-time roster information and the ability to solicit for volunteers before committee work starts;

k) To provide the organization and committee Chair with a near real-time ability to close committees to additional volunteers, to designate surplus volunteers as backup resources and automatically inform them of their backup status;

l) To automatically maintain committee-specific message distribution lists and to provide volunteers with the ability to easily send messages using these message distribution lists;

m) To provide a leadership candidate registration process including the ability to self-nominate or nominate others for leadership roles, to provide the organization with the ability to designate a Chair from a committee-specific slate of candidates, and to automatically notify candidates with the organization's decision;

n) To provide selected volunteers with the ability to generate reports based on their role within the organization, including reports about volunteers and committees;

o) To provide an online capability for volunteers to make suggestions and request assistance.

Still further objects and advantages will become apparent from a consideration of the ensuing description and drawings.

### SUMMARY

In accordance with the present invention, the volunteer registration and management process builds on several technologies, including networking, browsers, spreadsheet programs, database programs, and website programming to produce a novel, non-obvious system and method with useful benefits.

The system allows volunteers to register, join committees, communicate with other volunteers, make suggestions, get reports, and nominate leadership such as the organization's officers and committee Chairs. In addition, the system allows a committee Chair to open and close committees, receive notification when volunteers join or resign committees, and change a volunteer's status from active to backup. The system also allows an administrator to manage processes and data associated with the organization, committees and registered users. Lastly, the system allows a super-user to support multiple organizations and their administrators.

### BRIEF DESCRIPTION OF THE DRAWINGS

The objects, features, and advantages of the present invention will be apparent from the following detailed description of the preferred embodiment of the invention with references to the following drawings.

FIG. 1 presents process flows associated with displaying a list of system features, a demonstration of these features, the registration of a new organization or user, and logging onto the system for one embodiment of the present invention.

FIG. 2A presents process flows associated with user ID and password validation, storing user ID and password information on the user's local computer, and the correct presentation of either the Volunteer Menu or the Admin Menu for one embodiment of the present invention.

FIG. 2B presents a continuation of FIG. 2A.

FIG. 3 presents process flows associated with the registration of a new organization for one embodiment of the present invention.

FIG. 4 presents process flows associated with the registration of a new user for one embodiment of the present invention.

FIG. 5 presents process flows associated with the Volunteer Menu for one embodiment of the present invention.

FIG. 6 presents process flows associated with entering user-specific information such as a phone number for one embodiment of the present invention.

FIG. 7A presents process flows associated with joining a committee and displaying committee assignments for one embodiment of the present invention.

FIG. 7B presents a continuation of FIG. 7A.

FIG. 8 presents process flows associated with communicating with other users for one embodiment of the present invention.

FIG. 9A presents process flows associated with nominating leadership for one embodiment of the present invention.

FIG. 9B presents a continuation of FIG. 9A.

FIG. 10 presents process flows associated with making suggestions for one embodiment of the present invention.

FIG. 11 presents process flows associated with tools for committee Chairs for one embodiment of the present invention.

FIG. 12 presents process flows associated with getting reports for one embodiment of the present invention.

FIG. 13 presents process flows associated with the administrator menu for one embodiment of the present invention.

FIG. 14 presents process flows associated with organization modules for one embodiment of the present invention.

FIG. 15 presents process flows associated with entering organization-specific information such as the organization's name for one embodiment of the present invention.

FIG. 16 presents process flows associated with changing an organization's fiscal year for one embodiment of the present invention.

FIG. 17 presents process flows associated with sending thank you notes to an organization's users for one embodiment of the present invention.

FIG. 18A presents process flows associated with defining major groups of committees for one embodiment of the present invention.

FIG. 18B presents a continuation of FIG. 18A.

FIG. 19A presents process flows associated with defining sub-groups of committees within major groups and reassigning a sub-group to a different major group for one embodiment of the present invention.

FIG. 19B presents a continuation of FIG. 19A.

FIG. 20 presents process flows associated with obtaining a system license for one embodiment of the present invention.

FIG. 21 presents process flows associated with defining the organization's holidays for one embodiment of the present invention.

FIG. 22 presents process flows associated with committee modules for one embodiment of the present invention.

FIG. 23 presents process flows associated with creating a new committee for one embodiment of the present invention.

FIG. 24 presents process flows associated with modifying an existing committee for one embodiment of the present invention.

FIG. 25 presents process flows associated with designating a committee's Chair for one embodiment of the present invention.

FIG. 26 presents process flows associated with deleting a committee for one embodiment of the present invention.

FIG. 27 presents process flows associated with committee-specific overrides to the organization's holidays for one embodiment of the present invention.

FIG. 28 presents process flows associated with Volunteer Modules for one embodiment of the present invention.

FIG. 29 presents process flows associated with setting user-specific privileges for access to reports and sending messages for one embodiment of the present invention.

FIG. 30 presents process flows associated with resetting a user's logon ID and password for one embodiment of the present invention.

FIG. 31 presents process flows associated with setting a user's certification status and administrative permissions for one embodiment of the present invention.

FIG. 32 presents process flows associated with removing a user's committee assignment for one embodiment of the present invention.

FIG. 33 presents process flows associated with an administrator's request for support from the Super-user for one embodiment of the present invention.

FIG. 34 presents process flows associated with Super-user modules for one embodiment of the present invention.

FIG. 35 presents process flows associated with changing an organization's status and for deleting an organization from the system for one embodiment of the present invention.

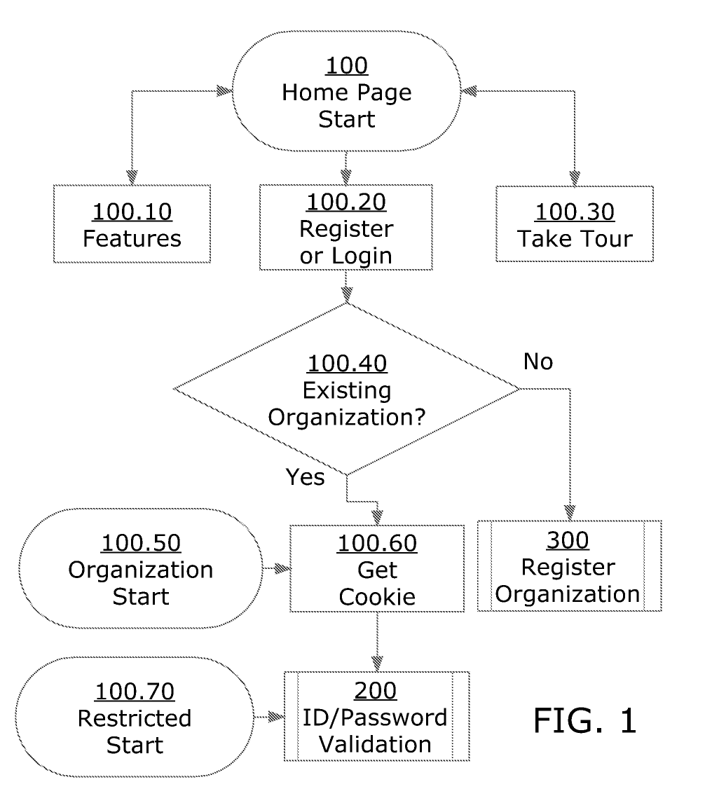

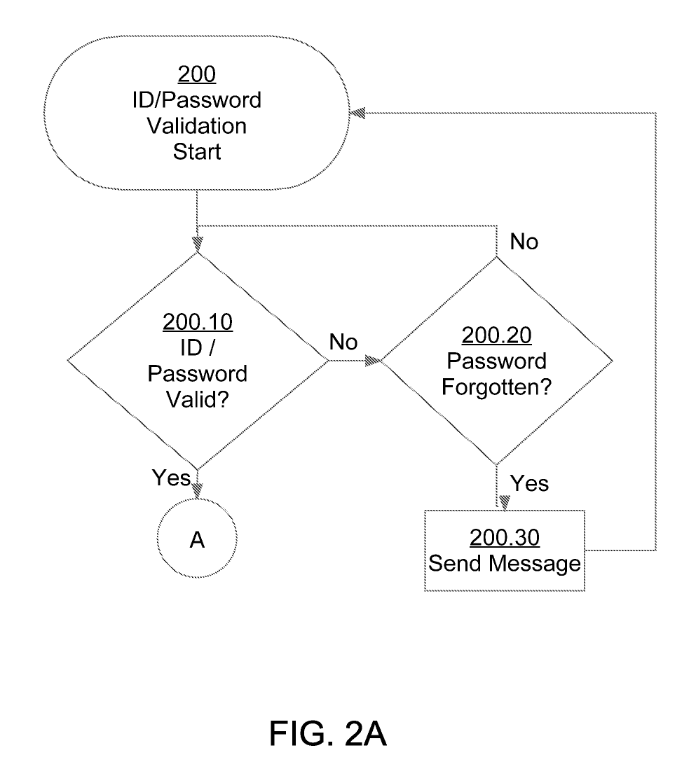

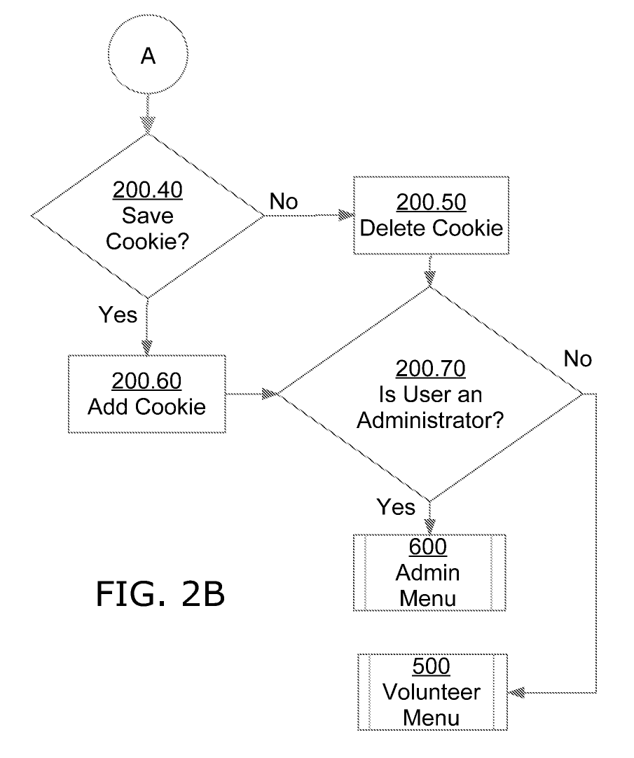

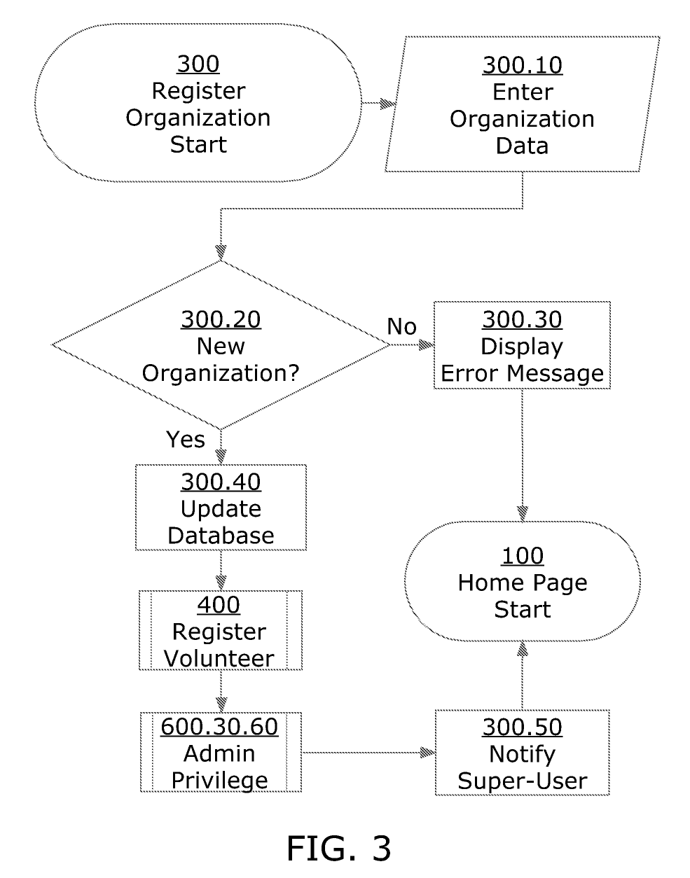

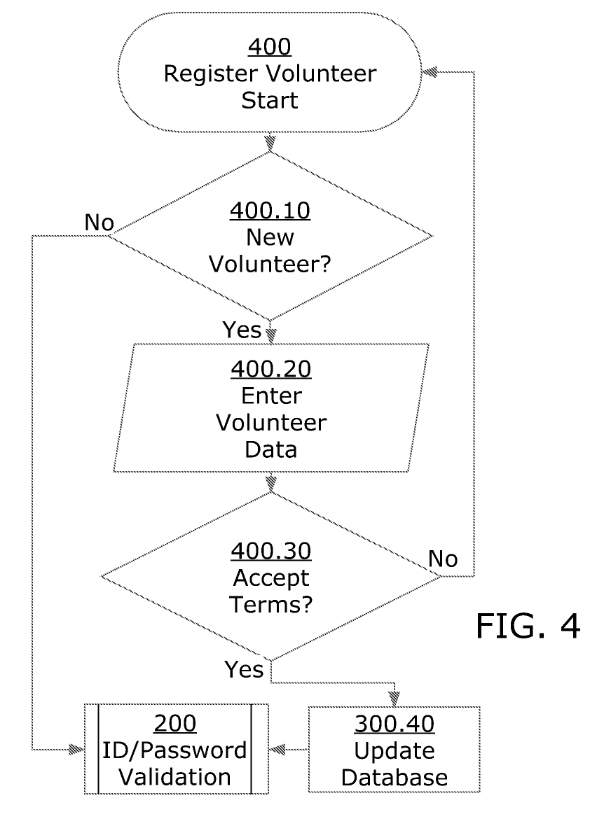

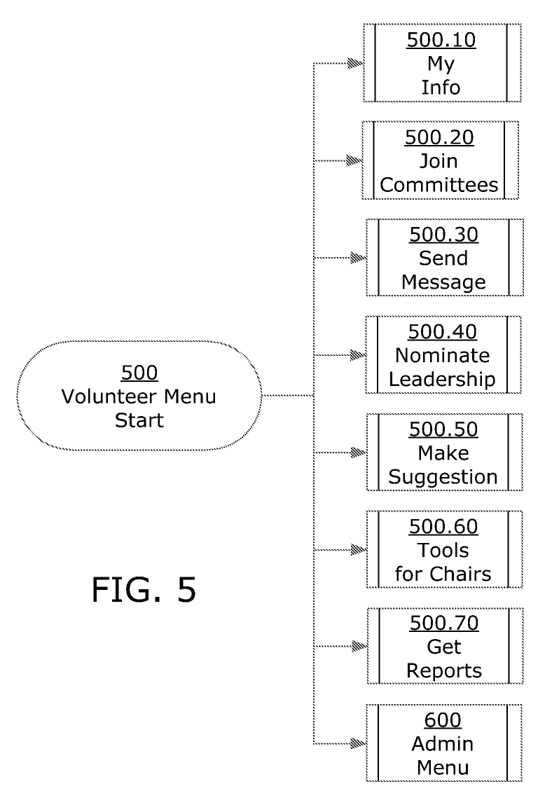

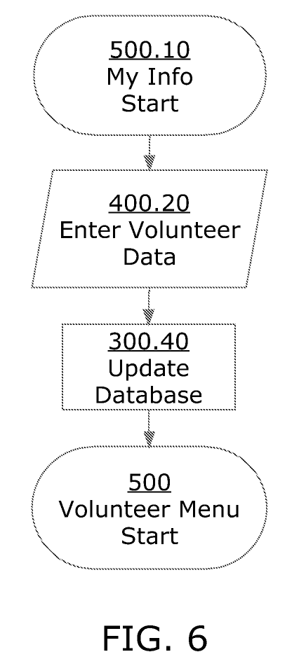

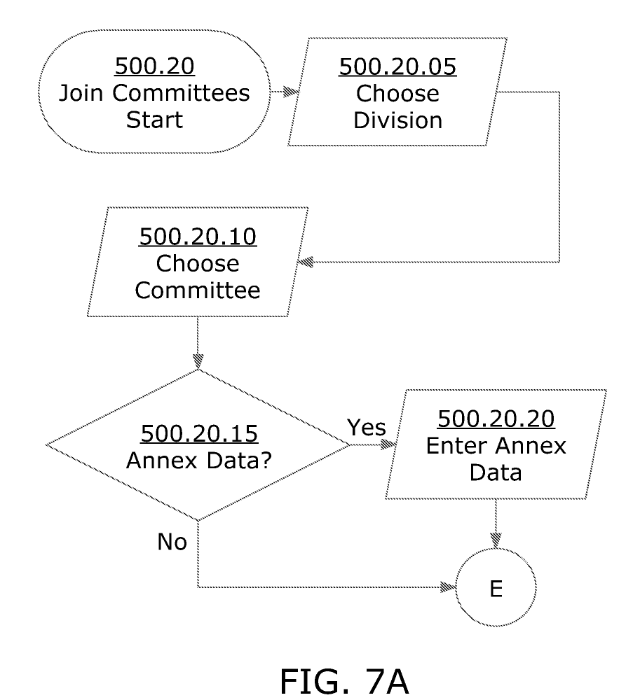

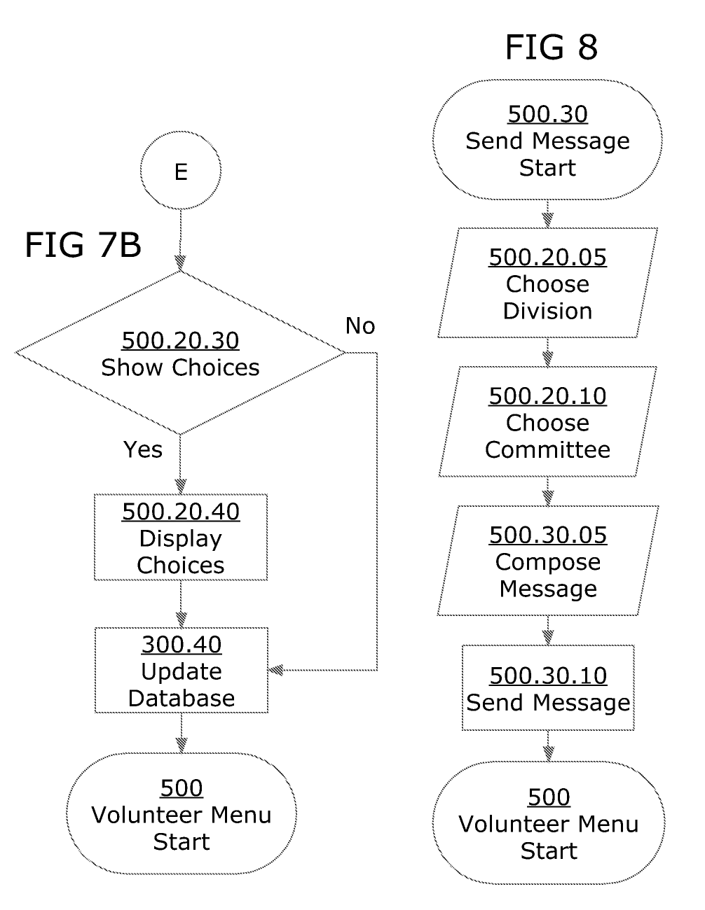

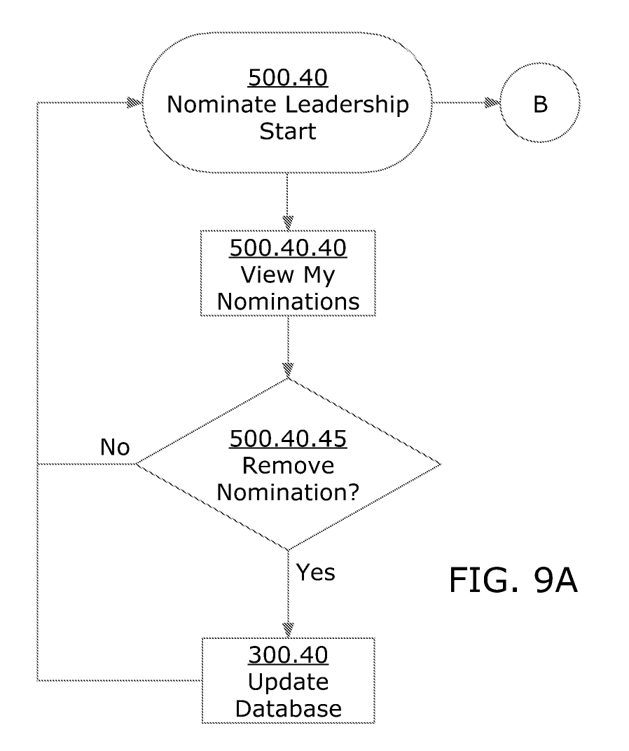

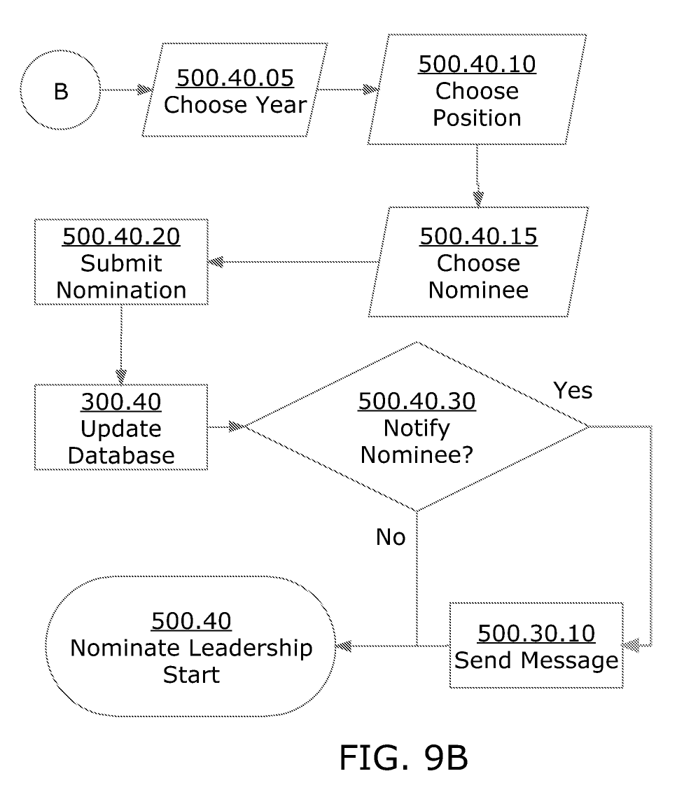

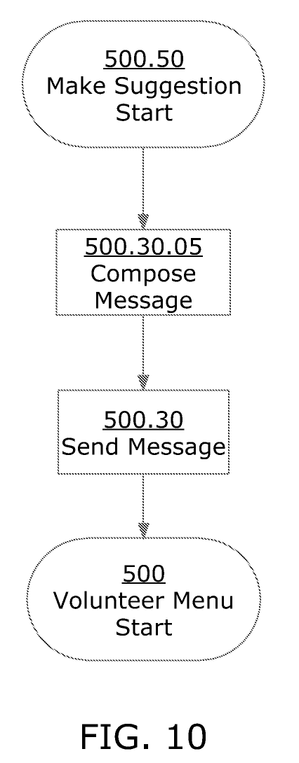

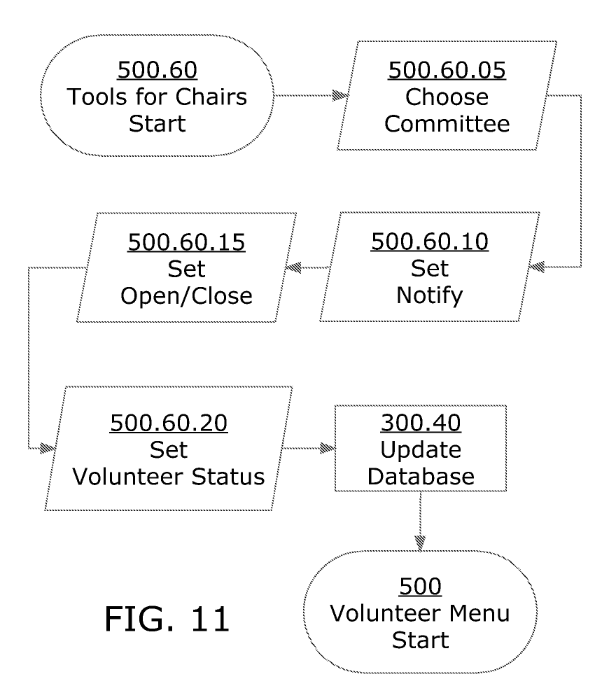

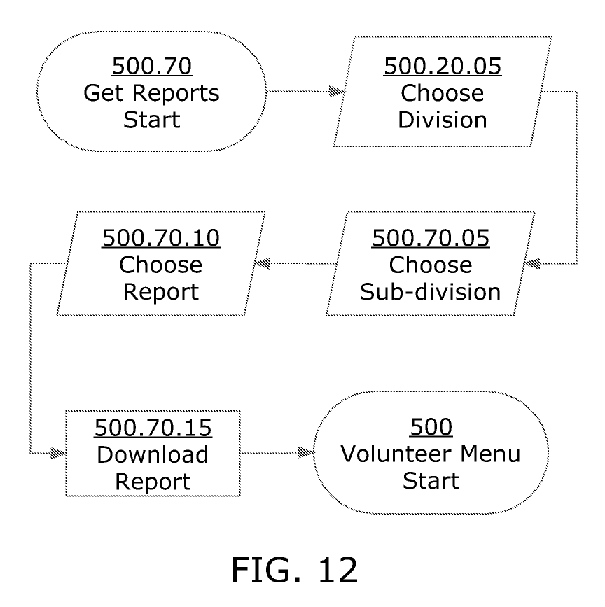

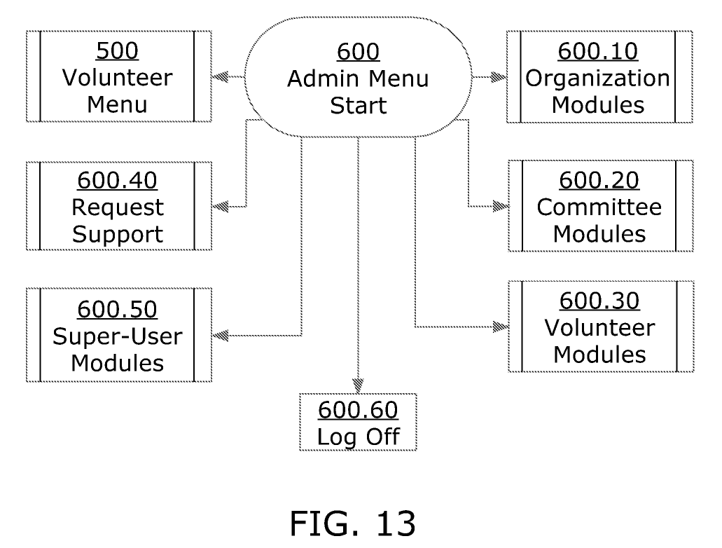

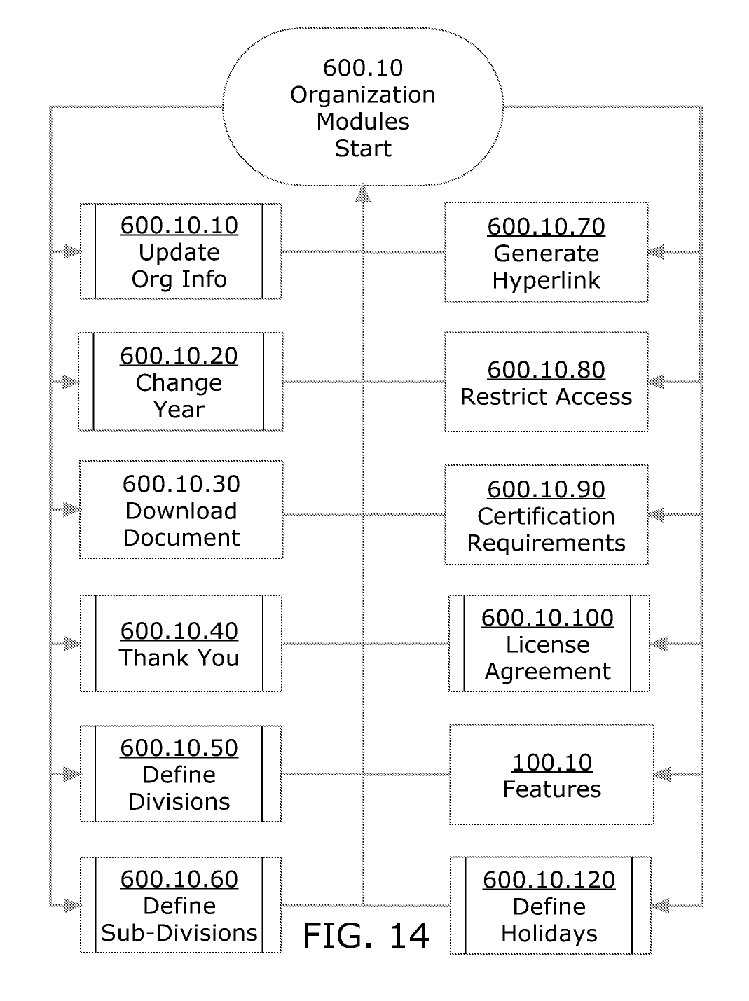

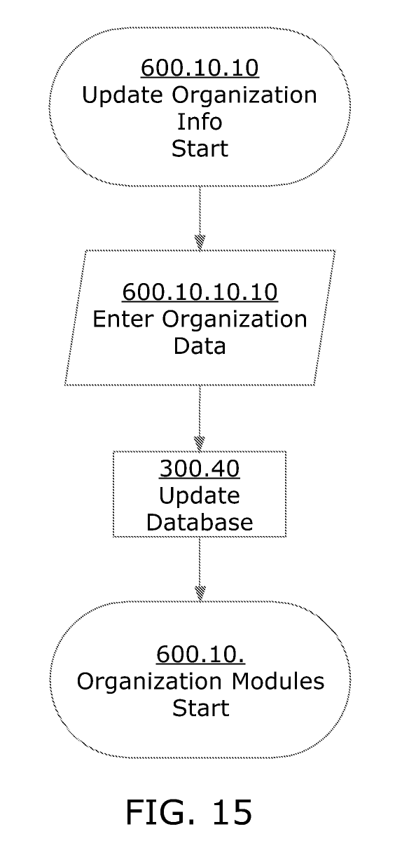

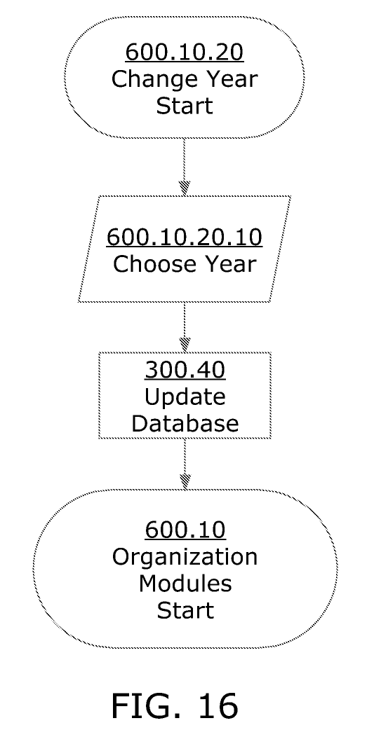

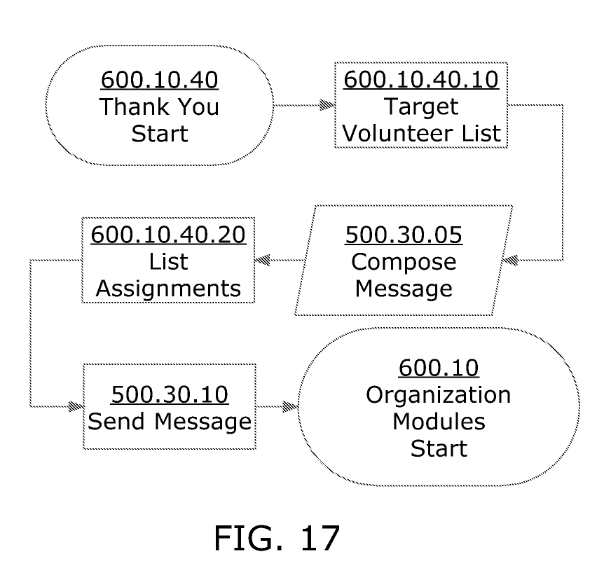

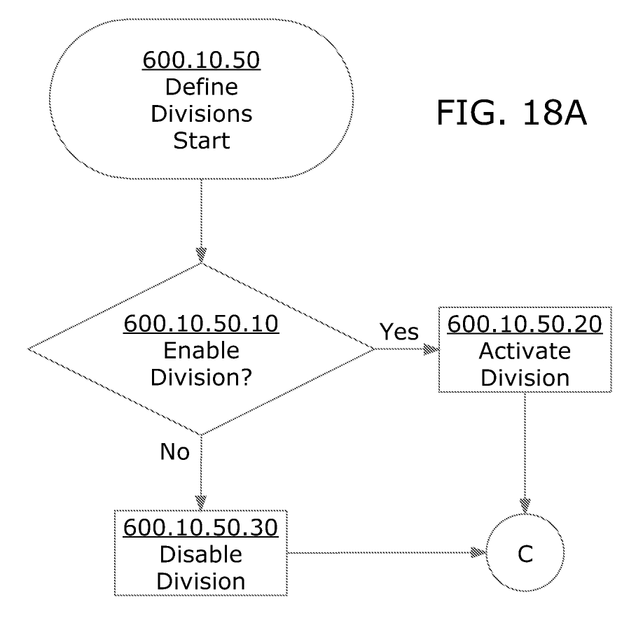

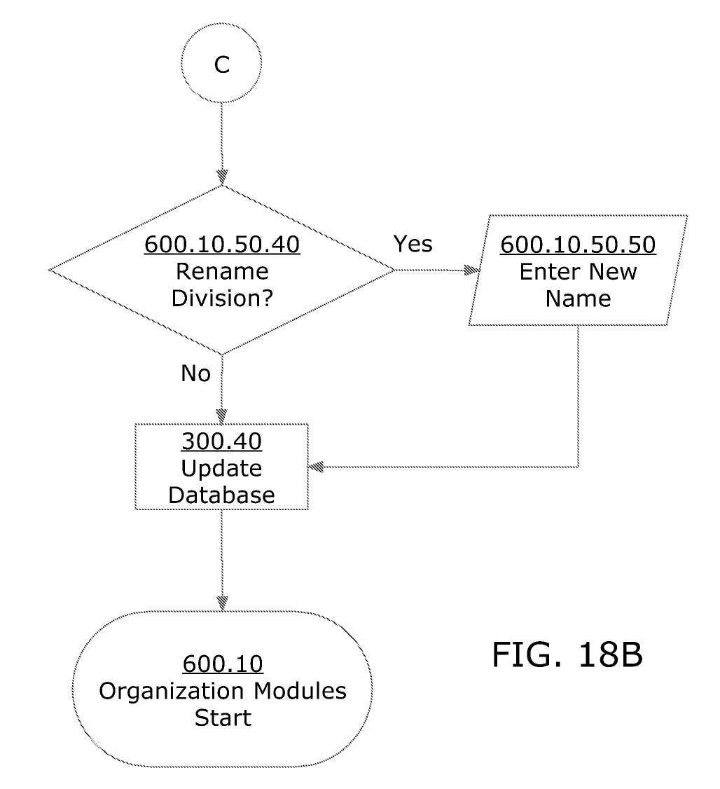

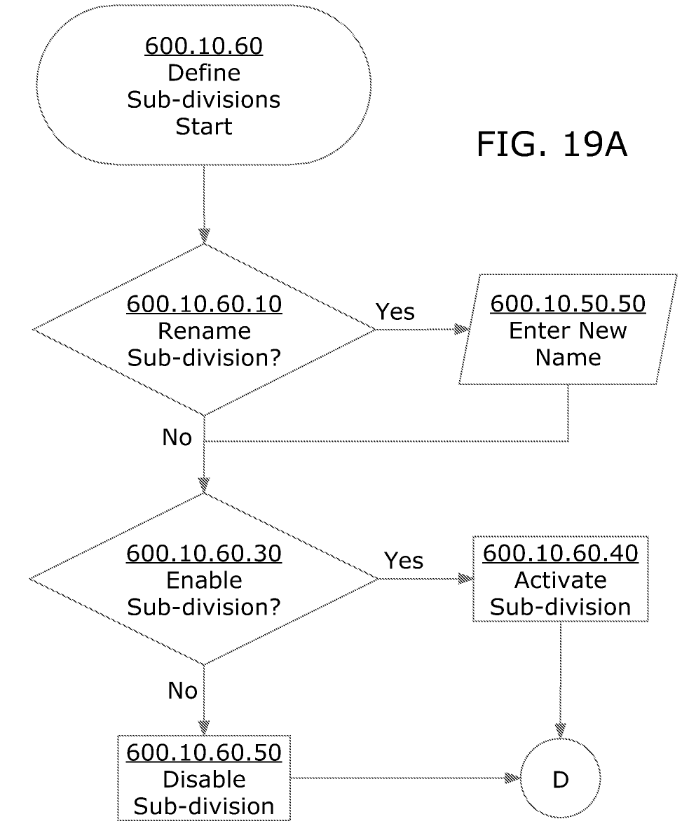

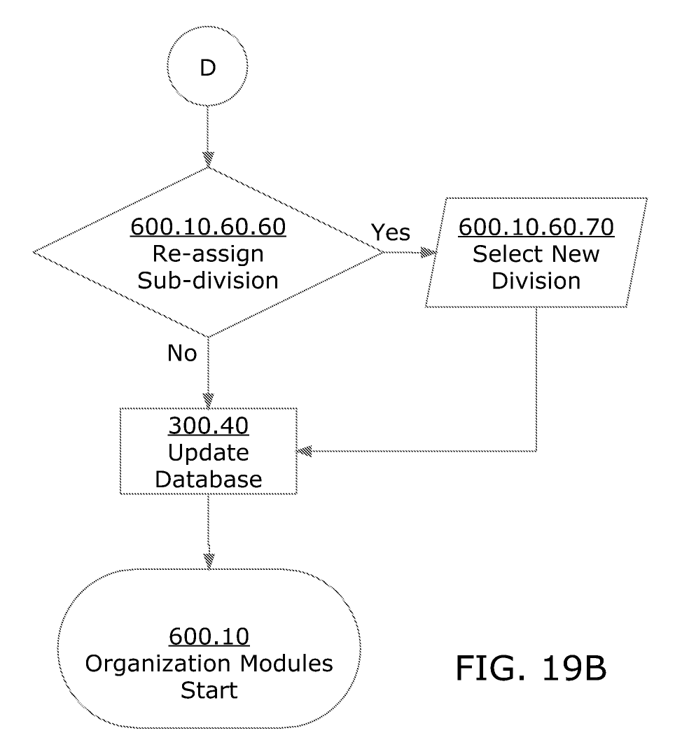

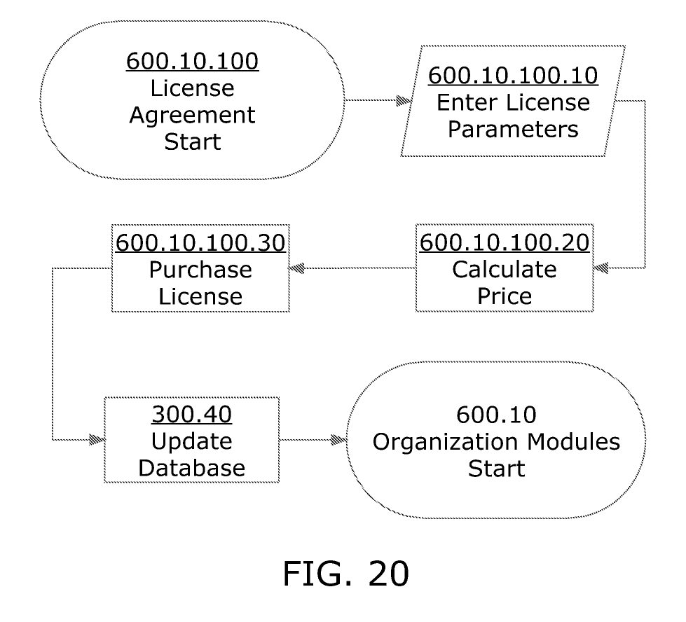

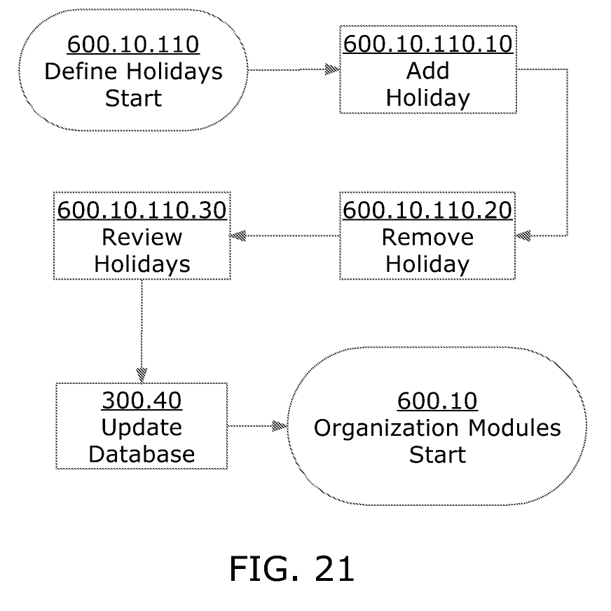

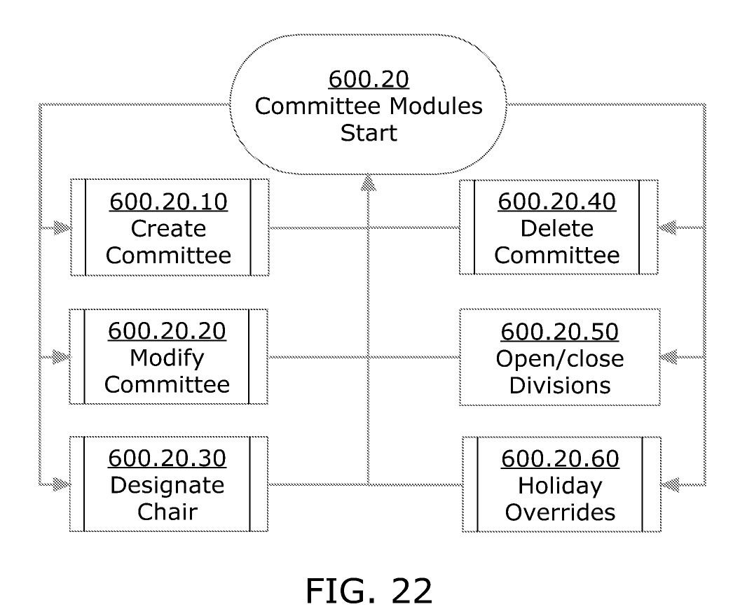

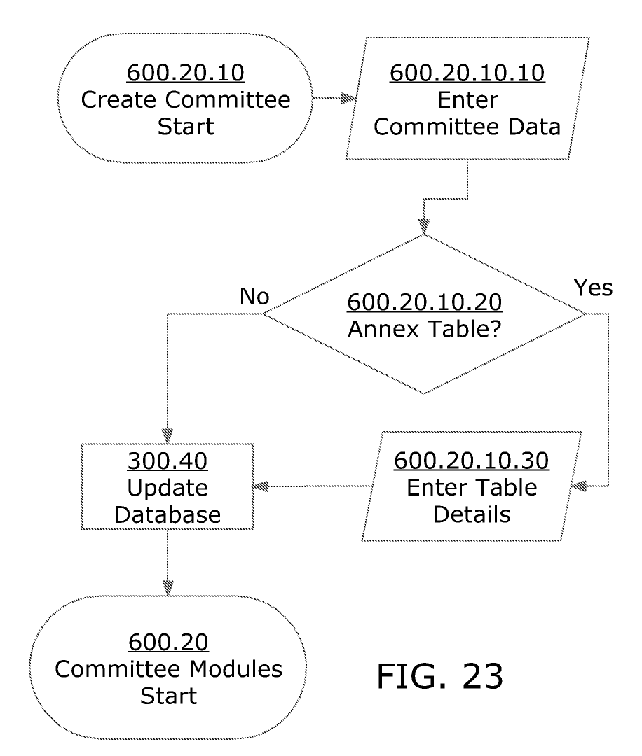

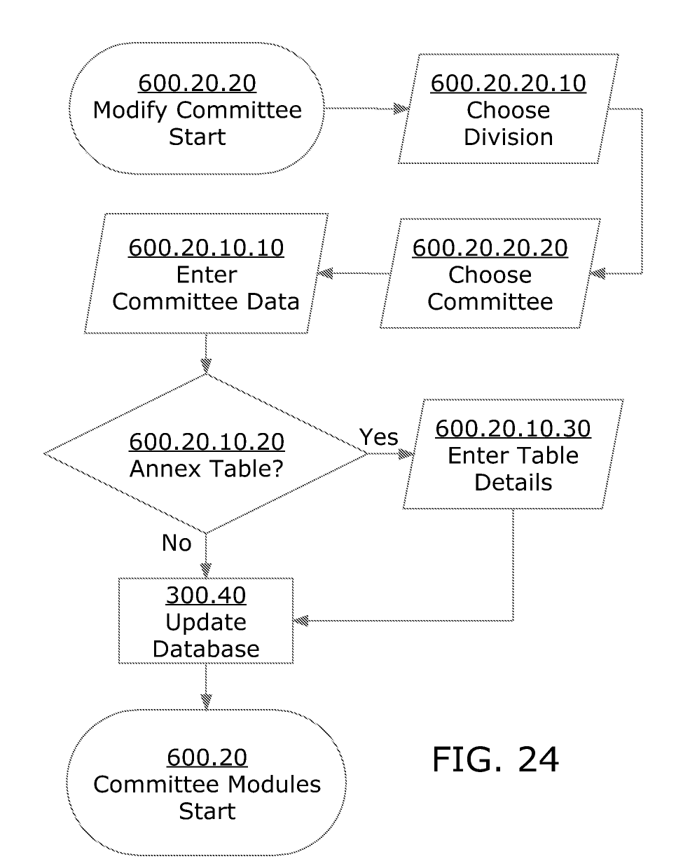

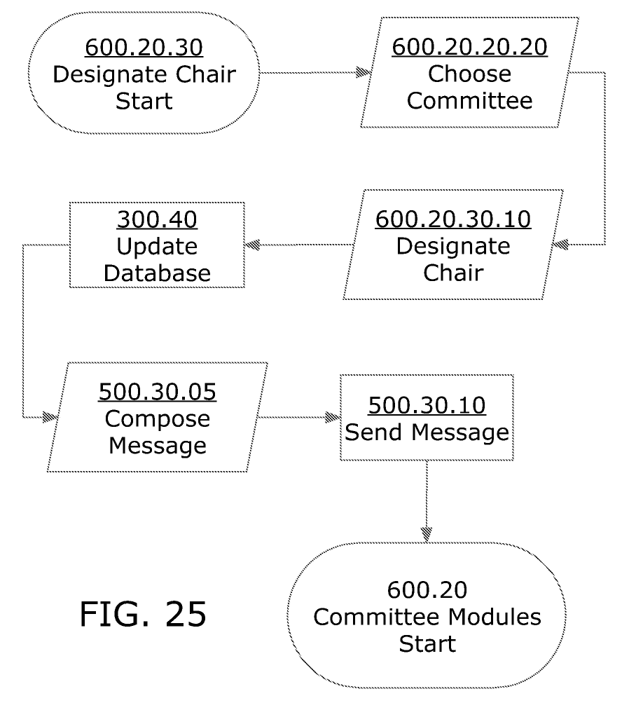

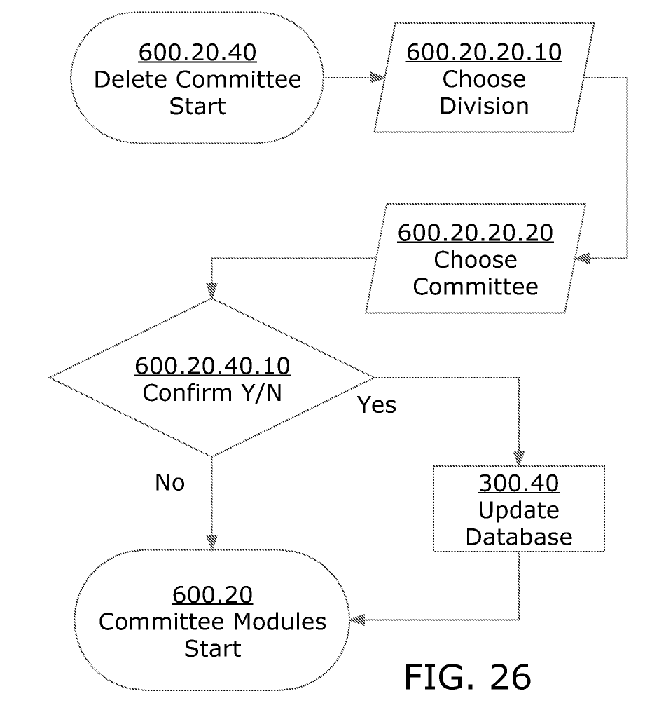

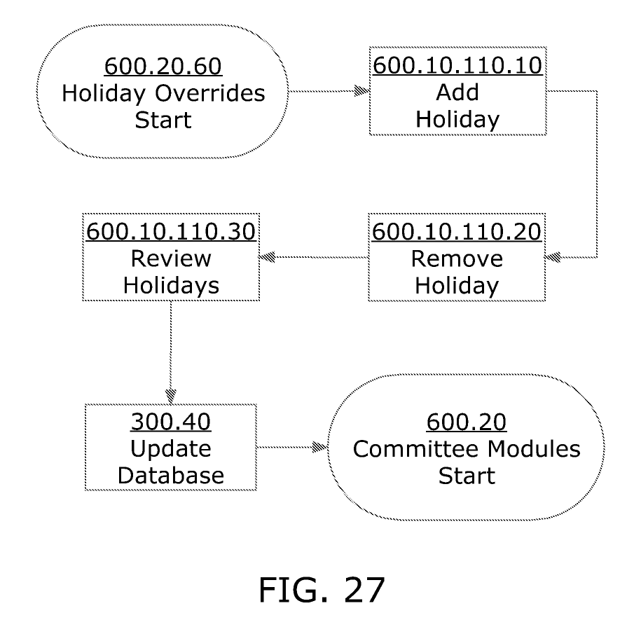

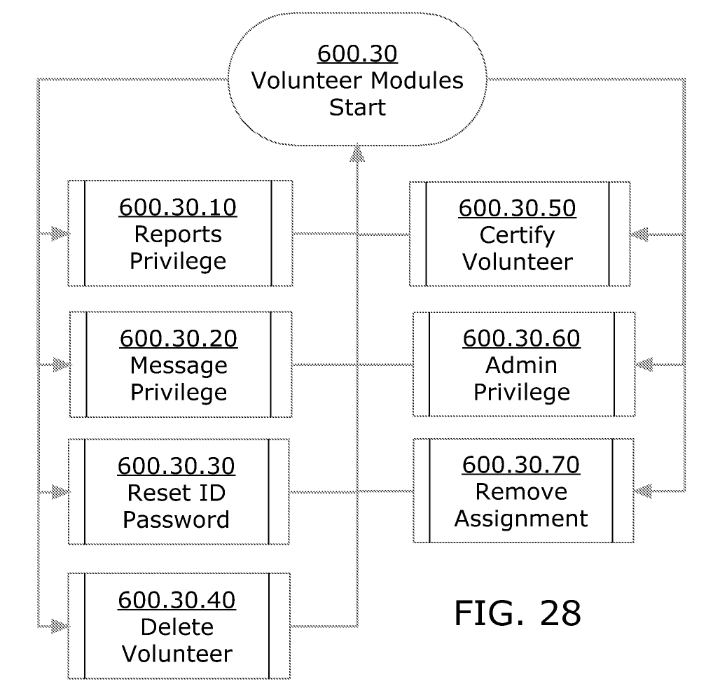

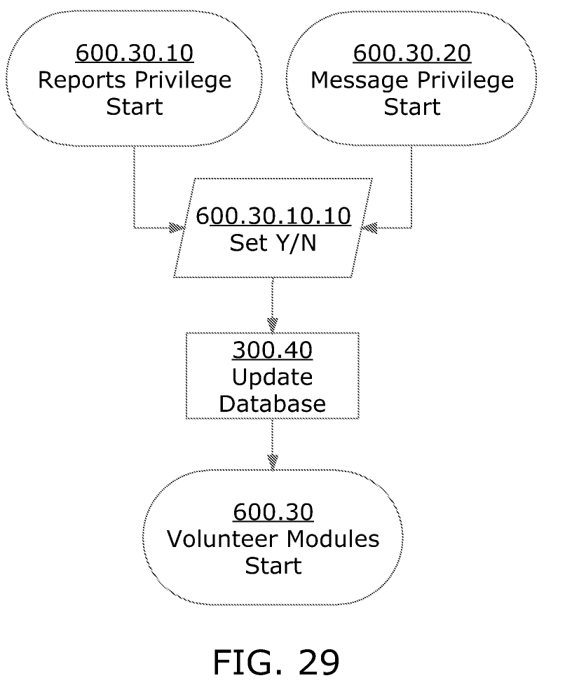

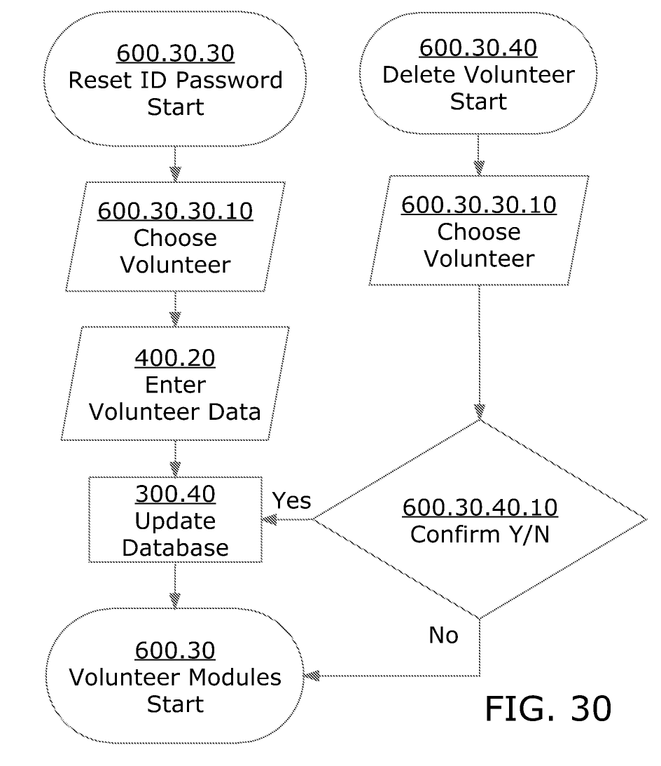

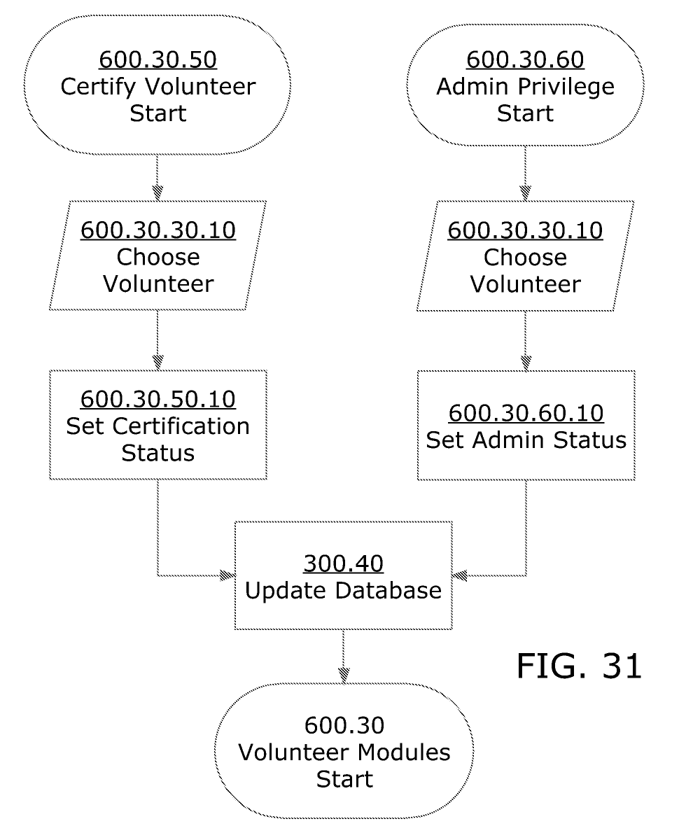

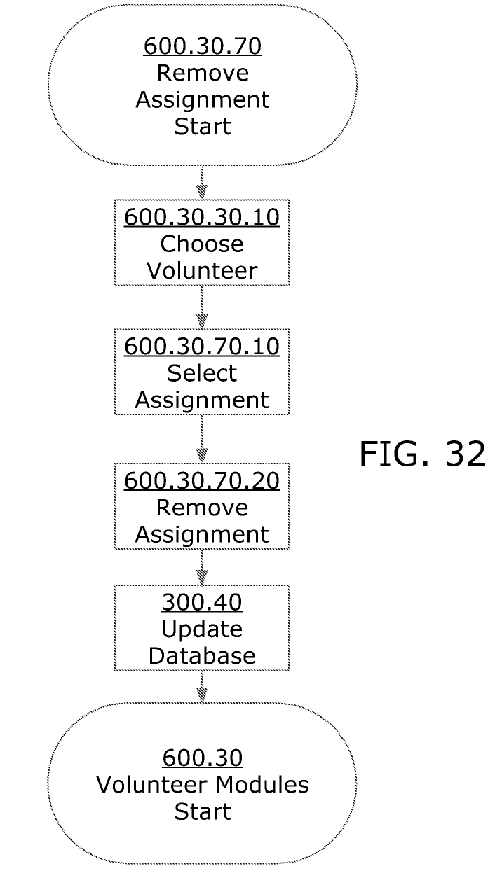

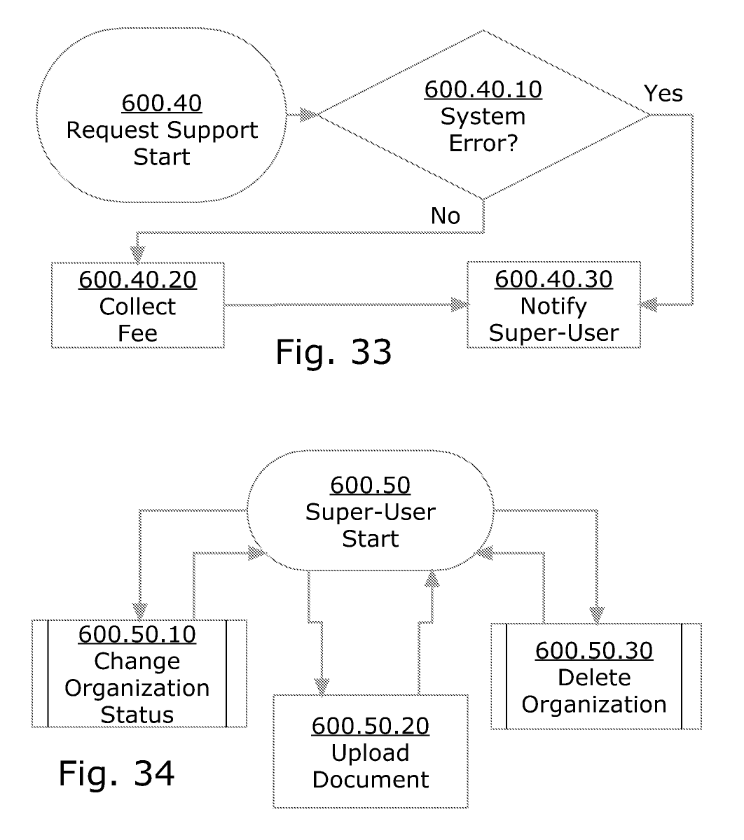

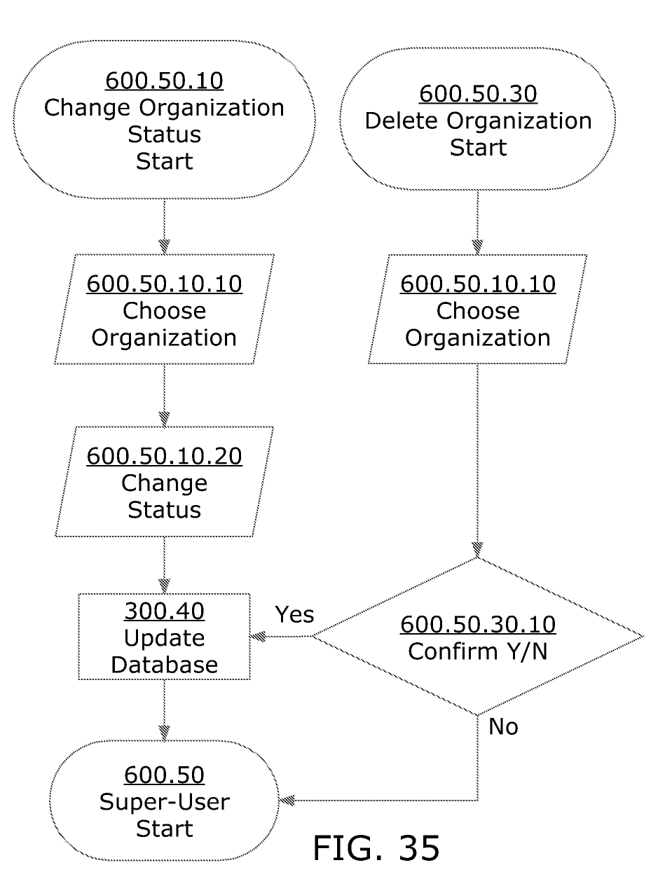

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

100. Home Page Start—Users may access the Volunteer Registration and Management Process from one of three entrances, including Home Page Start, Organization Start, and Restricted Start. Home Page Start serves all Internet users.
100.10. Features—This process displays the Website mission statement.
100.20. Register or Login—This process provides the ability to register for the first time or to enter a login ID and password if previously registered.
100.30. Take Tour—This process provides the user with the ability to experience the system's services.
100.40. Existing Organization?—This decision point allows the user to choose from a list of previously registered organization or to register a new organization.
100.50. Organization Start—This entrance serves users accessing the system from their organization's Home Page. The hyperlink on their organization's Home Page contains the organization ID and allows the user to skip to 100.60, “Get Cookie.” See also, 100, “Home Page Start.”
100.60. Get Cookie—This process attempts to retrieve a cookie from the user's local computer. The cookie contains the user's logon ID and password. If the cookie is not retrieved, the user must manually enter a logon ID and password.
100.70. Restricted Start—This entrance serves users who authenticate at their own organization's website. The hyperlink on their organization's website contains the organization ID, the user login ID, and the user password. This feature allows the user to access the Volunteer Registration and Management system without redundant authentication. In addition, organizations choosing this access method do not appear in the organization list (see 100.40, “Existing Organization?”), effectively blocking general network users from registering as a user for the organization in question.

200. ID/Password Validation—This subroutine authenticates users, manages cookies, and determines the user's Admin status, if any.
200.10. ID/Password Valid?—This decision point validates the user's login ID and Password.
200.20. Password Forgotten?—This decision point allows the user to request an email from the system containing the user's ID and password.
200.30. Send Message—This process sends a message containing the user's login ID and password to the user's message address.
200.40. Save Cookie—This decision point allows the user to add or delete the user's cookie on the user's local computer. This cookie contains the user's logon ID and password.
200.50. Delete Cookie—This process deletes the user's cookie from the user's local computer.
200.60. Add Cookie—This process adds the user's cookie to the user's local computer.
200.70. Is User an Administrator?—This decision point verifies the user's status and passes the user to the appropriate menu.

300. Register Organization—This subroutine gathers data about the new organization and adds it to the database.
300.10 Enter Organization Data—This data entry point provides the user with the capability to enter details about the organization.
300.20 New Organization?—This decision point ensures the organization has not been previously registered.
300.30 Display Error Message—This process advises the user that the organization has already been registered.
300.40 Update Database—This process updates the database with information captured in 300.10, “Enter Organization Data.”
300.50 Notify Super-User—This process sends a message to the super-user with information about the newly registered organization.

400. Register Volunteer—This subroutine gathers data about the new user and adds it to the database.
400.10 New Volunteer?—This decision point allows the user to register or to skip to the authentication subroutine, 200, “ID/PW Validation.”
400.20 Enter Volunteer Data—This data entry point provides the user with the capability to enter the user's contact information.
400.30 Accept Terms?—This check-box provides confirmation that the user accepts the terms and conditions associated with the Volunteer Registration and Management website.

500. Volunteer Menu—This subroutine presents the menu of choices for users. The user can navigate between menu choices using tabs located at the top of the page. These tabs remain available during execution of the various menu choices.
500.10 My Info—This tab allows the user to access and update the user's contact information.
500.20 Join Committees—This tab allows the user to join committees and to resign from them.
   500.20.05 Choose Division—The user chooses from a list of the organizations division. Organizing committees by division makes them easier for users to find.
   500.20.10 Choose Committee—To join a committee, the user clicks on a committee-specific check-box for the current year, the next year, or both. If joining the committee requires additional information, the check-box is replaced with a hyperlink labeled “More.”
   500.20.15 Annex Data?—Clicking on “More” allows the user to specify the additional information.
   500.20.20 Enter Annex Data—The user is presented with additional committee related questions. Among other things, these questions may include skills the user possesses, things the user can provide, and shifts the user can work.
   500.20.30 Show Choices?—This option allows the user to display committee assignments.
   500.20.40 Display Choices—The system displays the user's committee assignments.
500.30 Send Message—This subroutine allows users to send messages.
   500.30.05 Compose Message—This data entry point allows the user to create a formatted message.
   500.30.10 Send Message—This process allows the user to send the message. Alternatively, the user can abandon the message and not send it.
500.40 Nominate Leadership—This subroutine allows the user to self-nominate or nominate others for leadership positions such a committee Chair.
   500.40.05 Choose Year—The year pertains to the term of office for the leadership position. The user selects the current year, or the next year, but not both.
   500.40.10 Choose Position—The user selects the position from a list of leadership position choices.
   500.40.15 Choose Nominee—The user selects a nominee from a list of registered users.
   500.40.20 Submit Nomination—This process allows the user to submit the nominee. Alternatively, the user can abandon the nomination.
   500.40.30 Notify Nominee?—The user can choose whether or not to send a message to the nominee advising him/her of the nomination.
   500.40.40 View My Nominations—This process displays the list of the user's nominations. In addition, the list includes any positions for which others have nominated the user.
   500.40.45 Remove Nomination—The user can choose to remove any listed nomination.
500.50 Make Suggestion—This subroutine provides the user with the capability to send a message to the organization's Admin. If the Admin uses this subroutine, the suggestion routes to the website super-user.
500.60 Tools for Chairs—This subroutine provides committee Chairs with the capability to manage certain aspects related to their specific committee(s).
   500.60.05 Choose Committee—The system limits the list of committees to those for which the user is a Chair. The user can then choose which committee to manage.
   500.60.10 Set Notify—By default, the system sends a message to notify the Chair when a user joins the Chair's committee. The committee Chair can toggle this capability on or off.
   500.60.15 Set Open/Close—By default, the system allows users to join committees. The committee Chair can toggle this capability on or off. When off, the system grays-out the check-box associated with the committee. See 500.20.10, “Choose Committee.” This feature can prevent an overabundance of volunteers on any one committee.
   500.60.20 Set Volunteer Status—By default, users receive a committee-specific status of “volunteer” when they join a committee. This feature allows the committee Chair to change this status to “backup” or something similar. Using a message, the system notifies the user(s) in question of their status change.
500.70 Get Reports—This subroutine down-loads reports in spreadsheet format to the user's local computer. To open the report, the user must have spreadsheet software. By default, registered users do not have authorization to request reports. The Get Reports tab only appears if the user does have authorization to request reports. The system automatically grants authorization to committee Chairs and others in leadership positions. The Admin can toggle authorization on or off on a user-specific basis. See 600.35, “Report Authorization.”
   500.70.05 Choose Sub-division—The user limits the contents of the report to a specific grade.
   500.70.10 Choose Report—The user selects from a list of pre-defined reports and limits the contents of the report to the previous year, the current year, or the next year.
   500.70.15 Download Report—The system automatically generates and down-loads the report to the user's local computer. The system advises the user if the report has no contents and does not down-load a report.

600. Admin Menu—This subroutine presents the menu of choices for organization-specific administrators. In addition, this subroutine includes choices for the exclusive use of the Super-user.
600.10 Organization Modules—This tab presents a list of subroutines required to manage organization-specific processes and data.
   600.10.10 Update Organization Information—This subroutine supports the maintenance of organization-specific data.
      600.10.10.10 Enter Organization Data—Examples of organization data include name, physical address, phone number, website address, colors, images, message of the day, primary administrator, and backup administrator.
   600.10.20 Change Year—This subroutine supports the specification of an organization-specific, current operating year.
      600.10.20.10 Choose Year—The organization's administrator will choose a single year such as 2008.
   600.10.30 Download Document—This process downloads a document from the remote computer to the administrator's local computer. The Super-user provides this document using 600.50.20, “Upload Document.”
   600.10.40 Thank You—This subroutine sends a Thank You message to users. The organization's administrator chooses how frequently to run this subroutine.
      600.10.40.10 Target Volunteer List—The system compiles a list of volunteers who have joined a committee since the last Thank You message was sent.
      600.10.40.20 List Assignments—The system compiles a list of each volunteer's current committee assignments and appends the list to the message sent to that volunteer.
   600.10.50 Define Divisions—This subroutine allows the administrator to manage primary groups of committees.
      600.10.50.10 Enable Division?—This option provides a choice to enable or disable a division.
      600.10.50.20 Activate Division—This process enables use of a division.
      600.10.50.30 Disable Division—This process disables use of a division.
      600.10.50.40 Rename Division?—This option provides a choice to rename a division or keep the current name.
      600.10.50.50 Enter New Name—This process allows the administrator to enter a new name.
   600.10.60 Define Sub-divisions—This subroutine allows the administrator to manage secondary groups of committees.
      600.10.60.10 Rename Sub-division?—This option provides a choice to rename a sub-division or keep the current name.
      600.10.60.30 Enable Sub-division?—This option provides a choice to enable or disable a sub-division.
      600.10.60.40 Activate Sub-division—This process enables use of a sub-division.
      600.10.60.50 Disable Sub-division—This process disables use of a sub-division.
      600.10.60.60 Re-assign Sub-division?—This option provides a choice to move a sub-division between divisions.
      600.10.60.20 Select New Division—This process allows the administrator to assign a sub-division to a different division.
   600.10.70 Generate Hyperlink—This process sends a message containing an organization-specific hyperlink to the administrator. The hyperlink provides connectivity to 100.50, “Organization Start,” and includes a serial number unique to the organization.
   600.10.80 Restrict Access—This process removes or restores an organization's name on the list of organizations names presented in the 100.20, “Register or Login.” If the organization's name is removed, users can only login using 100.50, “Organization Start,” or 100.70 “Restricted Start.”
   600.10.90 Certification Requirement—This process activates or deactivates the requirement to certify users before they can join committees.
   600.10.100 License Agreement—This subroutine allows an administrator to change and renew the organization's license to use the system.
      600.10.100.10 Enter License Parameters—The administrator can enter license parameters such as class of service, term of license, and the number of users.
      600.10.100.20 Calculate Price—The system determines the price of the new license based on entered parameters and the value of the current license, if any.
      600.10.100.30 Purchase License—This process allows the administrator to accept the new contract price and pay for it.
   600.10.110 Define Holidays—This subroutine establishes organization-specific holidays.
      600.10.110.10 Add Holiday—This process allows the administrator to designate a calendar day as a holiday.
      600.10.110.20 Remove Holiday—This process allows the administrator to remove a calendar day from the organization's list of holidays.
      600.10.110.30 Review Holidays—This process allows the administrator to review the organization's list of holidays.
600.20 Committee Modules—This tab presents a list of subroutines required to manage committee-specific processes and data.
   600.20.10 Create Committee—This subroutine allows the administrator to establish a committee and define committee properties.
      600.20.10.10 Enter Committee Data—Examples of committee data include division, sub-division, name, description, the number of volunteers needed, and user certification requirement. Committee data would also include information needed from a prospective volunteer such as skills, work shift availability, and donation categories.
      600.20.10.20 Annex Table?—This option allows the administrator to specify if the committee needs information from a prospective volunteer beyond the user's basic contact information.
      600.20.10.30 Enter Table Details—This process allows the administrator to specify categories of additional, committee-specific information. Joining such a committee might require the user to check a box or specify a number associated with the category.
   600.20.20 Modify Committee—This subroutine allows the administrator to change committee properties.
      600.20.20.10 Choose Division—This process allows the administrator to select a division of committees.
      600.20.20.20 Choose Committee—This process allows the administrator to select a single committee.
   600.20.30 Designate Chair—This subroutine allows the administrator to designate a user as the Chair of a committee.
      600.20.30.10 Designate Chair—This process allows the administrator to designate a user as the Chair of a committee.
   600.20.40 Delete Committee—This subroutine allows the administrator to remove a committee.
      600.20.40.10 Confirm Y/N—This option allows the administrator to confirm deletion of a committee before the system deletes the committee.
   600.20.50 Open/Close Divisions—This process allows the administrator to open or close all of the committees within a division.
   600.20.60 Holiday Overrides—This subroutine allows the administrator to override organization holidays with committee-specific holidays.
600.30 Volunteer Modules—This tab presents a list of subroutines required to manage user-specific processes and data.
   600.30.10 Reports Privilege—This subroutine allows the administrator to extend and remove the privilege to obtain reports.
      600.30.10.10 Set Y/N—This process allows the administrator to extend and remove the privilege.
   600.30.20 Message Privilege—This subroutine allows the administrator to extend and remove the privilege to send messages.
   600.30.30 Reset ID/Password—This subroutine allows the administrator to change a user's ID and password.
      600.30.30.10 Choose Volunteer—This process allows the administrator to select a specific user.
   600.30.40 Delete Volunteer—This subroutine allows the administrator to delete a specific user.
      600.30.40.10 Confirm Y/N?—This option allows the administrator to confirm removal of a user from the system.
   600.30.50 Certify Volunteer—This subroutine allows the administrator to change the certification status of a specific user.
      600.30.50.10 Set Certification Status—This process allows the administrator to change the certification status of a specific user.
   600.30.60 Admin Privilege—This subroutine allows the administrator to extend and remove administrative privileges for a specific user.
      600.30.60.10 Set Admin Status—This process allows the administrator to extend and remove administrative privileges for a specific user.
   600.30.70 Remove Assignment—This subroutine allows the administrator to remove a committee assignment for a specific user.
      600.30.70.10 Select Assignment—This process allows the administrator to select one assignment from a list of assignments associated with a specific user.
      600.30.70.20 Remove Assignment—This subroutine allows the administrator to remove a committee assignment for a specific user.
600.40 Request Support—This subroutine allows the administrator to report system bugs for free and pay for other support services.
   600.40.10 System Error?—This option allows the administrator to choose between reporting a system bug and paying for support services.
   600.40.20 Collect Fee—This process allows the administrator to pay for support services.
   600.40.30 Notify Super-User—This process allows the administrator to send a message to the Super-User which explains the support request.
600.50 Super-User—This subroutine presents Super-User menu choices and only appears if the administrator is a Super-User.
   600.50.10 Change Organization Status—This subroutine allows the Super-User to change an organizations status.
      600.50.10.10 Choose Organization—This process allows the Super-User to target one specific organization.
      600.50.10.20 Change Status—This process allows the Super-User to change the targeted organization's status. In addition to service status such as active or suspended, status may also include such properties as class of service, license term, and maximum number of users.
   600.50.20 Upload Document—This process allows the Super-User to transfer a document from the Super-User's local computer to the system's remote computer.
   600.50.30 Delete Organization—This subroutine allows the Super-User to remove an organization from the system.
      600.50.30.10 Confirm Y/N—This option allows the Super-User to confirm removal of the organization from the system.
600.60 Log Off—This process terminates the user's terminal session.

I claim:

1. A system allowing a human being to specify and maintain data comprising a local computer hosting a browser, a remote computer hosting a database, a remote computer hosting a software program, a network connecting said local computer with said remote computer, and a messaging technology, comprising:
a. a system register to register as a volunteer for an organization,
b. a system committee to join and resign a committee of said organization,
c. a system communication to communicate among said volunteers,
d. a system chair to nominate a chair of said committee,
e. a system administrator for said chair to administer said committee,
f. a system suggestion for said volunteer to submit a suggestion to the system administrator for said organization,
g. a system report for said volunteer to generate a report.

2. The system of claim 1 wherein some said registered volunteers have privileges of said system administrator comprising:
a. a system organization data to administer said organization data comprising, an organization name, a fiscal year, a hierarchy, an access method, a certification status, a license and a holiday calendar,
b. a system committee data to administer said committee data comprising, a committee name, a committee description, a chair designation and a holiday calendar,
c. a system registered volunteer data to administer said registered volunteer data comprising, a report privilege status, a messaging privilege status, a logon name, a password, a system administrator status, and a committee membership status,
d. a system request support to request support.

3. A method for allowing a human being to specify and maintain data comprising a local computer hosting a browser, a remote computer hosting a database, a remote computer hosting a software program, a network connecting said local computer with said remote computer, and a messaging technology, comprising:
registering as a volunteer for an organization,
joining and resigning a committee of said organization,
communicating among said volunteers,
nominating a chair of said committee,
administering by said chair to said committee,
submitting for said volunteer a suggestion to a system administrator for said organization,
generating for said volunteer a report.

4. The method of claim 3 wherein some said registered volunteers have privileges of said system administrator comprising:
administering said organization data comprising, an organization name, a fiscal year, a hierarchy, an access method, a certification status, a license and a holiday calendar,
administering said committee data comprising, a committee name, a committee description, a chair designation and a holiday calendar, administering said registered volunteer data comprising, a report privilege status, a messaging privilege status, a logon name, a password, a system administrator status and a committee membership status; and
requesting support.
